(19) United States
(12) Patent Application Publication
(10) Pub. No.: US 2025/0374221 A1
(43) Pub. Date: Dec. 4, 2025

(54) RESOURCE RESERVATION FOR A POSITIONING REFERENCE SIGNAL

(71) Applicant: NOKIA TECHNOLOGIES OY, Espoo (FI)

(72) Inventors: Yan MENG, Shanghai (CN); Tao TAO, Shanghai (CN); Jian Guo LIU, Shanghai (CN); Mikko SÄILY, Espoo (FI); Muhammad Ikram ASHRAF, Espoo (FI)

(21) Appl. No.: 18/870,176

(22) PCT Filed: Aug. 10, 2022
(86) PCT No.: PCT/CN2022/111538

§ 371 Date: Nov. 27, 2024

(51) Int. Cl. H04W 64/00; H04L 5/00; H04W 24/08

(52) U.S. Cl. CPC H04W 64/00; H04L 5/0048; H04W 24/08

(57) ABSTRACT

Example embodiments of the subject disclosure relate to resource reservation for a positioning reference signal. A first device obtains a configuration indicating a resource for a positioning reference signal. The positioning reference signal is used to position a second device in a first area. The first device selects a set of third devices from a plurality of third devices in the first area. The first device transmits the configuration to the set of third devices for reserving the resource.

### FIELD

Various example embodiments of the subject disclosure generally relate to the field of telecommunication and in particular, to methods, devices, apparatuses and computer readable storage medium for resource reservation for a positioning reference signal.

### BACKGROUND

Location-awareness is an aspect of wireless communication networks that can enable a myriad of location-enabled services in different applications. The integration and utilization of location information in day-to-day applications is expected to grow as the technology's accuracy evolves.

With the fifth generation (5G) coverage rapidly expanding, new radio (NR) positioning is relevant to public commercial use cases as well as various industry applications, and thus attracts wide research from industry and academy. NR positioning, for instance, may be utilized to improve positioning accuracy for such use cases. However, with the rapid increase in the number of user equipment (UE), the resource efficiency of the positioning technology is generally expected to be further improved.

### SUMMARY

In a first example embodiment, there is provided a first device. The first device comprises at least one processor; and at least one memory storing instructions that, when executed by the at least one processor, cause the first device at least to: obtain a configuration indicating a resource for a positioning reference signal for a second device in a first area; select, from a plurality of third devices in the first area, a set of third devices by which the resource is to be reserved; and transmit the configuration to the set of third devices.

In a second example embodiment, there is provided a second device. The second device comprises at least one processor; and at least one memory storing instructions that, when executed by the at least one processor, cause the second device in a first area at least to: receive, from a fourth device serving the second device or a first device, a configuration indicating a resource for a positioning reference signal for the second device, the resource being reserved by a set of third devices selected from a plurality of third devices in the first area; and transmit, to a fifth device measuring the positioning reference signal, the positioning reference signal by using the resource.

In a third example embodiment, there is provided a third device. The third device comprises at least one processor; and at least one memory storing instructions that, when executed by the at least one processor, cause the third device at least to: receive, from a first device, a configuration indicating a resource for a positioning reference signal for a second device in a first area, the third device being selected from a plurality of third devices in the first area; and reserve the resource for the positioning reference signal based on the configuration.

In a fourth example embodiment, there is provided a fourth device. The fourth device comprises at least one processor; and at least one memory storing instructions that, when executed by the at least one processor, cause the fourth device at least to: determine a resource for a positioning reference signal for a second device in a first area; and transmit, to a first device and the second device, a configuration indicating the resource, the resource being reserved by a set of third devices selected by the first device from a plurality of third devices in the first area.

In a fifth example embodiment, there is provided a sixth device. The sixth device comprises at least one processor; and at least one memory storing instructions that, when executed by the at least one processor, cause the sixth device at least to: obtain update information concerning an update of a second area in which a second device is located; and based on the obtaining of the update information, transmit, to a first device, information indicating that the second device leaves the second area.

In a sixth example embodiment, there is provided a method. The method comprises: obtaining, at a first device, a configuration indicating a resource for a positioning reference signal for a second device in a first area; selecting, from a plurality of third devices in the first area, a set of third devices by which the resource is to be reserved; and transmitting the configuration to the set of third devices.

In a seventh example embodiment, there is provided a method. The method comprises: receiving, at a second device in a first area from a fourth device serving the second device or a first device, a configuration indicating a resource for a positioning reference signal for the second device, the resource being reserved by a set of third devices selected from a plurality of third devices in the first area; and transmitting, to a fifth device measuring the positioning reference signal, the positioning reference signal by using the resource.

In an eighth example embodiment, there is provided a method. The method comprises: receiving, at a third device from a first device, a configuration indicating a resource for a positioning reference signal for a second device in a first area, the third device being selected from a plurality of third devices in the first area; and reserving the resource for the positioning reference signal based on the configuration.

In a ninth example embodiment, there is provided a method. The method comprises: determining, at a fourth device, a resource for a positioning reference signal for a second device in a first area; and transmitting, to a first device and the second device, a configuration indicating the resource, the resource being reserved by a set of third devices selected by the first device from a plurality of third devices in the first area.

In a tenth example embodiment, there is provided a method. The method comprises: obtaining, at a sixth device, update information concerning an update of a second area in which a second device is located; and based on the obtaining of the update information, transmitting, to a first device, information indicating that the second device leaves the second area.

In an eleventh example embodiment, there is provided a first apparatus. The first apparatus comprises: means for obtaining a configuration indicating a resource for a positioning reference signal for a second apparatus in a first area; means for selecting, from a plurality of third apparatuses in the first area, a set of third apparatuses by which the resource is to be reserved; and means for transmitting the configuration to the set of third apparatuses.

In a twelfth example embodiment, there is provided a second apparatus. The second apparatus comprises: means for receiving, from a fourth apparatus serving the second apparatus in a first area or a first apparatus, a configuration indicating a resource for a positioning reference signal for the second apparatus, the resource being reserved by a set of third apparatuses selected from a plurality of third apparatuses in the first area; and means for transmitting, to a fifth apparatus measuring the positioning reference signal, the positioning reference signal by using the resource.

In a thirteenth example embodiment, there is provided a third apparatus. The third apparatus comprises: means for receiving, from a first apparatus, a configuration indicating a resource for a positioning reference signal for a second apparatus in a first area, the third apparatus being selected from a plurality of third apparatuses in the first area; and means for reserving the resource for the positioning reference signal based on the configuration.

In a fourteenth example embodiment, there is provided a fourth apparatus. The fourth apparatus comprises: means for determining a resource for a positioning reference signal for a second apparatus in a first area; and means for transmitting, to a first apparatus and the second apparatus, a configuration indicating the resource, the resource being reserved by a set of third apparatuses selected by the first apparatus from a plurality of third apparatuses in the first area.

In a fifteenth example embodiment, there is provided a sixth apparatus. The sixth apparatus comprises: means for obtaining update information concerning an update of a second area in which a second apparatus is located; and means for based on the obtaining of the update information, transmitting, to a first apparatus, information indicating that the second apparatus leaves the second area.

In a sixteenth example embodiment, there is provided a computer readable medium. The computer readable medium comprises instructions stored thereon for causing an apparatus to perform at least the method according to the first example embodiment.

In a seventeenth example embodiment, there is provided a computer readable medium. The computer readable medium comprises instructions stored thereon for causing an apparatus to perform at least the method according to the second example embodiment.

In an eighteenth example embodiment, there is provided a computer readable medium. The computer readable medium comprises instructions stored thereon for causing an apparatus to perform at least the method according to the third example embodiment.

In a nineteenth example embodiment, there is provided a computer readable medium. The computer readable medium comprises instructions stored thereon for causing an apparatus to perform at least the method according to the fourth example embodiment.

In a twentieth example embodiment, there is provided a computer readable medium. The computer readable medium comprises instructions stored thereon for causing an apparatus to perform at least the method according to the fifth example embodiment.

It is to be understood that the Summary section is not intended to identify key or essential features of example embodiments, nor is it intended to be used to limit the scope of the subject disclosure. Other features of the subject disclosure will be understood through the following description.

### BRIEF DESCRIPTION OF THE DRAWINGS

Some example embodiments will now be described with reference to the accompanying drawings, where:

FIG. 1A illustrates an example communication environment in which example embodiments can be implemented;

FIG. 1B illustrates another example communication environment in which example embodiments can be implemented;

FIG. 2 illustrates a signaling chart for resource reservation according to some example embodiments;

FIG. 3 illustrates a signaling chart for resource validation according to some example embodiments;

FIG. 4 illustrates another signaling chart for resource validation according to some example embodiments;

FIG. 5 illustrates a flowchart of an example method implemented at a first device in accordance with some example embodiments;

FIG. 6 illustrates a flowchart of an example method implemented at a second device in accordance with some example embodiments;

FIG. 7 illustrates a flowchart of an example method implemented at a third device in accordance with some example embodiments;

FIG. 8 illustrates a flowchart of an example method implemented at a fourth device in accordance with some example embodiments;

FIG. 9 illustrates a flowchart of an example method implemented at a sixth device in accordance with some example embodiments;

FIG. 10 is a simplified block diagram of a device that is suitable for implementing example embodiments; and

FIG. 11 illustrates a block diagram of an example computer readable medium in accordance with some example embodiments.

Throughout the drawings, the same or similar reference numerals represent the same or similar element.

### DETAILED DESCRIPTION

The subject disclosure will now be described with reference to some example embodiments. It is to be understood that these example embodiments are described only for the purpose of illustration and help those skilled in the art to understand and implement the subject disclosure, without suggesting any limitation as to the scope of the disclosure. Example embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the subject disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term herein, including in any claims. As a further example embodiment, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Example embodiments may be applied in various communication systems. Given the rapid development in communications, there will of course also be future type communication technologies and systems with which the example embodiments may be applied. It should not be seen as limiting the scope of the example embodiments to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments. It is noted that example embodiments are equally applicable to other resources in other domains.

### Example Environment

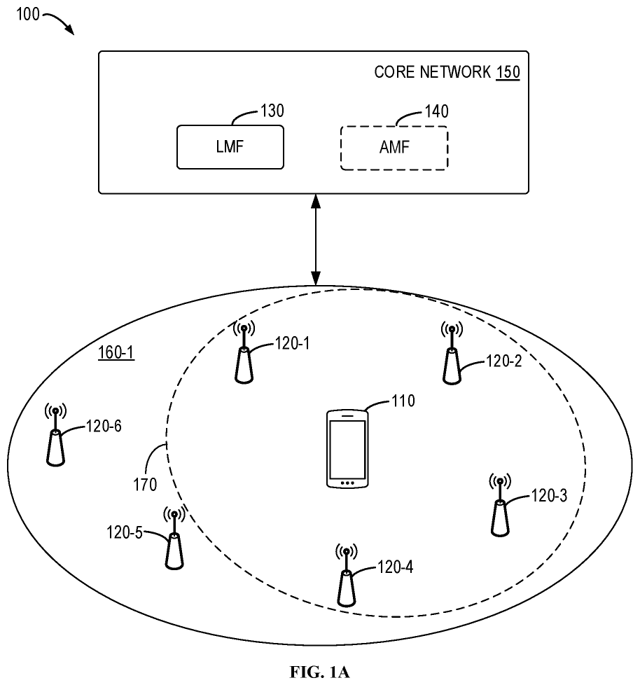

FIG. 1A illustrates an example communication environment 100 in which example embodiments can be implemented. As shown in FIG. 1A, the communication environment 100 comprises a terminal device 110, a core network 150 and network devices 120-1, 120-2, 120-3, 120-4, 120-5 and 120-6 (individually referred to as a network device 120 or collectively referred to as network devices 120 hereinafter). The terminal device 110 and the network device 120 are located in an area 160-1. A network device 120 (for example, the network device 120-4) in the proximity of the terminal device 110 may serve the terminal device 110. A link from the network device 120 to the terminal device 110 is referred to as a downlink (DL), while a link from the terminal device 110 to the network device 120 is referred to as an uplink (UL). In DL, the network device 120 is a transmitting (TX) device (or a transmitter) and the terminal device 110 is a receiving (RX) device (or a receiver). In UL, the terminal device 110 is a TX device (or a transmitter) and the network device 120 is a RX device (or a receiver).

The area 160-1 in which the terminal device 110 is located may change as the terminal device 110 moves. FIG. 1B illustrates another example communication environment 102 in which example embodiments can be implemented. As shown in FIG. 1B, the terminal device 110 leaves the area 160-1 and moves into the area 160-2. The areas 160-1 and 160-2 are individually referred to as an area 160 or collectively referred to as areas 160 hereinafter. Compared with the communication environment 100, the communication environment 102 further comprises network devices 120-7, 120-8 and 120-9 (together with network devices 120-1, 120-2, 120-3, 120-4, 120-5 and 120-6 individually referred to as a network device 120 or collectively referred to as network devices 120 hereinafter). By way of example, in the example of FIG. 1B, a network device 120 (for example, the network device 120-7) in the proximity of the terminal device 110 may serve the terminal device 110.

In the examples of FIG. 1A and FIG. 1B, the core network 150 may comprise access and mobility management function (AMF) 140 and location management function (LMF) 130. The AMF 140 maintains the non-access stratum (NAS) signaling connection with the terminal device 110 and manages the registration process. The LMF 130 receives measurements and assistance information from the 5G radio access network (5G-RAN) and the terminal device 110 to determine the position of the terminal device 110.

It is to be understood that the number of devices and connections therebetween shown in FIG. 1A and FIG. 1B are only for the purpose of illustration without suggesting any limitation. The communication environments 100 and 102 may include any suitable number of devices configured to implementing example embodiments. Although not shown, it would be appreciated that one or more additional devices may be located in the area 160, and one or more additional devices may be deployed in the communication environment 100.

Communications in the communication environments 100 and 102 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

For various commercial use cases, access to position information of the terminal device 110 can be acquired. To this end, various positioning technologies are developed for positioning the terminal device 110. In UL positioning, one or more network devices 120 may be configured to measure uplink positioning reference signal transmitted by the terminal device 110, and reported to LMF, and the LMF 130 may determine the position of the terminal device 110 based on the reported measurement. As used herein, the term “positioning reference signal (PRS)” refers to a reference signal used to position the terminal device 110. The PRS may comprise, but is not limited to, sounding reference signal (SRS), physical random access channel (PRACH) preambles, or the like.

In 5G communication networks, the terminal device 110 may switch between a plurality of radio resource control (RRC) states, including RRC_CONNECTED state, RRC_IDLE state and RRC_INACTIVE state. The RRC_CONNECTED state is optimized for high UE activity, while the RRC_IDLE state is optimized for low consumption of power and network resources. The RRC_INACTIVE state is introduced for 5G communication networks to achieve power saving with acceptable access latency, so that the terminal device 110 is able to return to the RRC_CONNECTED state quickly and efficiently. In RRC_INACTIVE state, the terminal device 110 does not have an RRC connection with the 5G-RAN, although the 5G-RAN keeps a connection with the core network 150. A RAN-based notification area (RNA) is introduced and allows the core network 150 and the 5G-RAN to determine the location of the terminal device 110, such as an identification of a cell serving the terminal device 110 or a geographical location of the terminal device 110, when the terminal device 110 is in RRC_INACTIVE state. The RNA may comprise one or more serving areas (e.g., cells) of a set of network devices 120. In some example embodiments, the area 160-1 may be an RNA.

For support of UL positioning, it's required to configure UL PRS parameters including, but not limited to, reference signal sequence and transmission occasions for positioning UE. In a solution, UL PRS parameters may be configured by the serving gNB. When a UE moves from one serving gNB to a new serving gNB, the new serving gNB needs to re-configure UL PRS according to its own preference in RRC_CONNECTED state. For UL positioning in RRC_INACTIVE state, when the UE moves from one serving gNB to a new serving gNB within the RNA, it needs to resume RRC connection with the new serving gNB and obtain UL PRS update from the new serving gNB. In order to resume the RRC in the new serving gNB, the network may also relocate the UE access stratum (AS) context from the last serving gNB to the new serving gNB. However, the related procedure in this solution can cause high power consumption at UE and large positioning latency due to RRC resume process.

In a further solution, one common SRS resource is configured for a predetermined positioning area (e.g., RNA) including a plurality of cells, so as to facilitate the lower power positioning in RRC_IDLE state and RRC_INACTIVE state. The UE can continue transmitting SRS without updating SRS configuration within the positioning area. The UE can keep the SRS configuration in a positioning area where the network device 120 can receive SRS and the UE can transmit the SRS. When the UE moves out of the positioning area, it then establishes the connection to the network to request updating SRS. The SRS configurations are transmitted to the RAN nodes in the area of configured cells, who would reserve the resource for this UE for SRS transmission. That is, the SRS resource can't be used for other UL transmission. However, this solution can cause large resource overhead, since each gNB in the RNA reserves the common SRS resource for UL positioning. Moreover, the number of UEs that can be served is also limited in this solution.

In view of the drawbacks of the above-mentioned solutions, it is expected to further improve resource efficiency for UL positioning.

### Work Principle and Example Signaling for Resource Reservation

According to some example embodiments, there is provided a solution for resource reservation for a PRS. In this solution, a first device obtains a configuration indicating a resource for a PRS. The PRS is used to position a second device in a first area. The first device selects a set of third devices from a plurality of third devices in the first area. The first device transmits the configuration to the set of third devices for reserving the resource.

According to example embodiment, some of the plurality of third devices are selected to reserve the resource for the PRS. In this manner, it is possible to avoid unnecessary resource reservation at all of the plurality of third devices in an area. The example embodiments can thus improve the resource efficiency and increase the number of UEs that can be served at one gNB.

Example embodiments will be described in detail below with reference to the accompanying drawings.

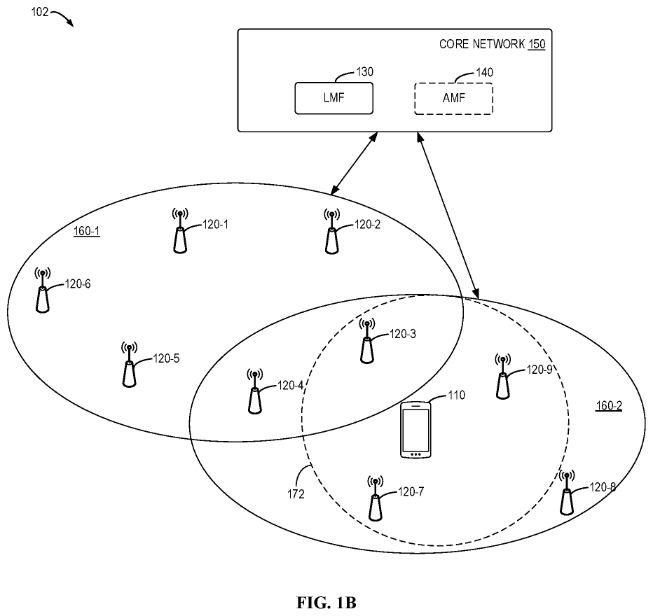

FIG. 2 shows a signaling chart 200 for resource reservation according to some example embodiments. As shown in FIG. 2, the signaling chart 200 involves a first device 201, a second device 202, a set of third devices 2031, an updated set of third devices 2032 and a fourth device 204. For the purpose of discussion, reference is made to FIG. 1A and FIG. 1B to describe the signaling chart 200. In some example embodiments, the first device 201 may be the LMF 130, the second device 202 may be the terminal device 110, the set of third devices 2031 may be the network devices 120-1, 120-2 and 120-3, and the fourth device 204 may be the network device 120-4. In some example embodiments, the second device 202 may be in the RRC_INACTIVE state or RRC_IDLE state.

Although one first device 201 and one second device 202 are illustrated in FIG. 2, it would be appreciated that there may be a plurality of first devices performing similar operations as described with respect to the first device 201 below and a plurality of second devices performing similar operations as described with respect to the second device 202 below.

The first device 201 obtains a configuration indicating a resource for a PRS (also referred to as “PRS resource” hereinafter) for a second device 202 in a first area. In the example embodiments where the second device 202 comprises a terminal device and the third devices comprise network devices, the PRS may be a UL PRS, such as an SRS. The resource may include, but is not limited to, time resource, frequency resource, code domain resource, and/or the like. In some example embodiments, the first area may be a geographical area. In some alternative example embodiments, the first area may be a coverage of at least one third devices. As an example, the first area may comprise a plurality of cells. As a further example, the first area may be the RNA.

In some example embodiments, the first device 201 may configure the PRS resource for the second device 202, and transmit the configuration indicating the PRS resource to the second device 202. Alternatively, in some example embodiments, as shown in FIG. 2, the fourth device 204 may determine 210 the PRS resource and transmit 215 the configuration indicating the PRS resource to the first device 201 and the second device 202. Accordingly, the first device 201 may receive 220 the configuration indicating the PRS resource from the fourth device 204.

The second device 202 receives 225 the configuration from the fourth device 204 or receives the configuration from the first device 201. The second device 202 may transmit the PRS to at least a fifth device (not shown in FIG. 2) by using the resource. The fifth device may measure the PRS on the resource and report the measurement results to the first device 201, so that the first device 201 can determine the position of the second device 202.

The first device 201 selects 225 a set of third devices 2031 from a plurality of third devices in the first area to reserve the resource. In some example embodiments, the set of third devices 2031 may be selected based on at least one of the following: a location of the second device 202, locations of the plurality of third devices, a location of a fourth device 204 serving the second device 202, or a signal quality of the PRS received by a set of fifth devices measuring the second device 202.

In some example embodiments, the initial location of the second device 202 may be the location when the second device 202 switches to RRC_INACTIVE state or RRC_IDLE state. As an example, a location may be denoted by geographical coordinates. The first device 201 may select the set of third devices 2031 based on the geographical coordinates of the second device 202 and the plurality of third devices. For example, the first device 201 may determine the distance between the second device 202 and each of the plurality of third devices. If the distance is below a threshold, the corresponding third device may be selected. With reference to FIG. 1A, the LMF 130 may determine the distance between the terminal device 110 and each of the network devices 120, and the network devices 120-1, 120-2, 120-3, and 120-4 may be selected as the set of third devices, i.e., the initial set 170 in FIG. 1A, since the distances between the terminal device 110 and these selected network devices 120 are below a threshold while the distances between the terminal device 110 and the network devices 120-5 and 120-6 are larger than the threshold. The threshold may be predetermined in a specification or be configured by the network (e.g., the network device 120 or the LMF 130).

In some alternative example embodiments, the set of third devices 2031 may be selected based on locations of the fourth device 204 and the plurality of third devices. For example, the first device 201 may determine the distance between the fourth device 204 and each of the plurality of third devices. If the distance is below a threshold, the corresponding third device may be selected.

In some alternative example embodiments, the set of third devices 2031 may be selected based on a signal quality of the PRS received by the set of fifth devices. For example, reference signal received power (RSRP) may be used as a metric for the signal quality. If the RSRP of PRS received by a fifth device is larger than a threshold, the fifth device is selected. The threshold may be predetermined in a specification or be configured by the network (e.g., the network device 120 or the LMF 130). It should be understood that any other suitable metric (for example, reference signal received quality (RSRQ)) may also be used as a metric for the signal quality. The scope of the example embodiments is not limited in this respect.

It should be understood that the possible implementations of the selection of the set of third devices 2031 described above are merely illustrative and therefore should not be construed as limiting the example embodiments in any way.

Continuing with FIG. 2, the first transmits 235 the configuration indicting the resource to the set of third devices 2031 selected at 225. At the side of the set of third devices 2031, they receive 240 the configuration and reserve 245 the resource based on the configuration.

It is seen that one or more selected third devices need to reserve the resource for UL positioning. Thereby, the example embodiments can avoid unnecessary resource reservation at all of the third devices in an area and thus effectively improve the resource efficiency.

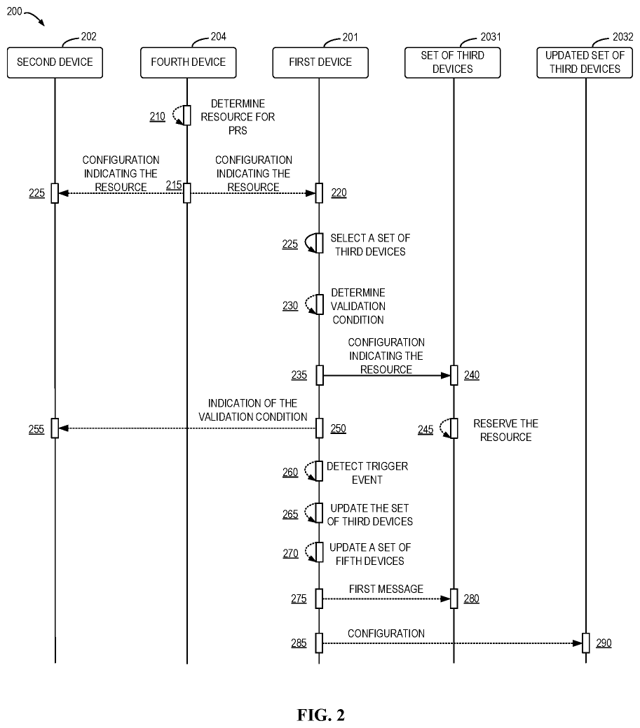

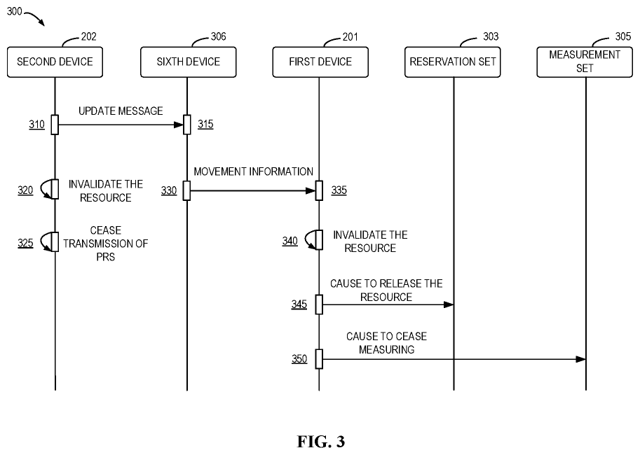

In some example embodiments, the first device 201 may determine 230 a validation condition used for determining whether the configuration is valid to be used, for example, in RRC_INACTIVE state. The first device 201 may transmit 250 an indication of the validation condition to the second device 202. The validation condition specifies a condition to invalidate the PRS resource. After receiving 255 the indication of the validation condition (also referred to as “validation indication” hereinafter), the second device 202 may determine the validity of the PRS resource according to the validation condition. The second device 202 may invalidate the PRS resource based on (e.g., upon) the validation condition is satisfied. The validation condition will be described in detail with reference to FIG. 3 and FIG. 4 hereinafter.

The first device 201 may detect 260 a trigger event related to movement of the second device 202. In some example embodiments, the trigger event may comprise a change of the location of the second device 202. As an example, if the change of the location of the second device 202 is larger than a threshold, a trigger event can be detected. With reference to FIG. 1A and FIG. 1B, since the distance between the previous location and the current location of the terminal device 110 is larger than a threshold, a trigger event is detected by the LMF 130. The threshold may be predetermined in a specification or be configured by the network (e.g., the network device 120 or the LMF 130). Alternatively, if the second device 202 moves out of the coverage of the set of third devices 2031 or is moving at the boundary of the coverage, the trigger event can be detected.

In some alternative or additional example embodiments, the trigger event may comprise a degradation of a signal quality of the PRS received by a set of fifth devices measuring the second device 202. For example, RSRP may be used as a metric for the signal quality. If the RSRP of PRS received by a fifth device is smaller than a first threshold, the fifth device may be taken as a removed device. If the number of the removed devices is larger than a second threshold, a trigger event is detected by the LMF 130. The first threshold and/or the second threshold may be predetermined in a specification or be configured by the network (e.g., the network device 120 or the LMF 130).

In some alternative or additional example embodiments, the trigger event may comprise a change of a fourth device 204 serving the second device 202. As an example, if the new fourth device 204 serving the second device 202 is located at the boundary or outside of the coverage of the set of third devices 2031, a trigger event is detected by the first device 201. With reference to FIG. 1A and FIG. 1B, when the terminal device 110 moves, the serving network device 120 for the terminal device 110 may be relocated for some other purpose, e.g., initiate small data transmission (SDT) for other UL data or other positioning data transmission by RRC resume request. LMF 130 may determine that the serving network device 120 of the terminal device 110 has moved outside of the coverage of the selected network devices 120. A trigger event can be detected by the LMF 130.

In some alternative or additional example embodiments, the trigger event may comprise the second device 202 leaving the first area. As an example, the first area may be the RNA. When the second device 202 leaves the RNA, it transmits an RNA update message which cause the first device 201 to be informed that the second device 202 leaves the RNA. Thereby, a trigger event is detected by the first device 201. With reference to FIG. 1A and FIG. 1B, when the terminal device 110 moves out of the area 160-1, it transmits an RNA update message to AMF 140, and the AMF 140 informs the LMF 130 that the terminal has moved out of the area 160-1. Then, trigger event is detected by the LMF 130.

It should be understood that the possible implementations of the trigger event described above are merely illustrative and therefore should not be construed as limiting the example embodiments in any way.

Continuing with FIG. 2, the first device 201 may update 265 the set of third devices 2031 in accordance with a determination that the trigger event is detected, so as to obtain an updated set of third devices 2032. In some example embodiments, the set of third devices 2031 is updated based on at least one of the following: a location of the second device 202, locations of the plurality of third devices, a location of a fourth device 204 serving the second device 202, or a signal quality of the PRS received by the set of fifth devices.

In some example embodiments, the location may be denoted by the geographical coordinates. The first device 201 may update the set of third devices 2031 based on the geographical coordinates of the second device 202 and the plurality of third devices. For example, the first device 201 may determine the distance between the second device 202 and each of the plurality of third devices. If the distance is below a threshold, the corresponding third device may be added into the set of third devices 2031. If the distance is larger than or equal to the threshold, the corresponding third device may be removed from the set of third devices 2031. The threshold may be predetermined in a specification or be configured by the network (e.g., the network device 120 or the LMF 130). For the example shown in FIG. 1B, the LMF 130 may determine the distance between the terminal device 110 and each of the network devices 120, and the network devices 120-3, 120-7, and 120-9 may be selected as the updated set of third devices, i.e., the updated set 172 in FIG. 1B, since the distances between the terminal device 110 and the network devices 120-3, 120-7, and 120-9 are below a threshold while the distances between the terminal device 110 and the remaining network devices 120 are larger than the threshold. In this case, the network devices 120-1, 120-2 and 120-4 may be removed from the initial set 170, and the network devices 120-7 and 120-9 may be added into the initial set 170, so as to obtain the updated set 172.

In some alternative example embodiments, the set of third devices 2031 may be updated based on locations of the current fourth device 204 and the plurality of third devices. For example, the first device 201 may determine the distance between the current fourth device 204 and each of the plurality of third devices. If the distance is below a threshold, the corresponding third device may be added into the set of third devices 2031. If the distance is larger than or equal to the threshold, the corresponding third device may be removed from the set of third devices 2031. The threshold may be predetermined in a specification or be configured by the network (e.g., the network device 120 or the LMF 130).

In some alternative example embodiments, the set of third devices 2031 may be updated based on a signal quality of the PRS received by the set of fifth devices. For example, RSRP may be used as a metric for the signal quality. If the RSRP of PRS received by a fifth device is larger than a threshold, the fifth device is added into the set of third devices 2031. If the RSRP of PRS received by a fifth device is smaller than or equal to a threshold, the fifth device is removed from the set of third devices 2031. The threshold may be predetermined in a specification or be configured by the network (e.g., the network device 120 or the LMF 130). It should be understood that any other suitable metric (for example, reference signal received quality (RSRQ)) may also be used as a metric for the signal quality. The scope of the example embodiments is not limited in this respect.

It should be understood that the possible implementations of the update of the set of third devices 2031 described above are merely illustrative and therefore should not be construed as limiting the example embodiments in any way.

The first device 201 may transmit 275 a first message to a third device removed from the set of third devices 2031 to cause the third device to release the resource. In some example embodiments, the first message may indicate the configuration for the PRS resource, a time window or time offset when the third device should release the PRS resource, a request for releasing the PRS resource, and/or the like. The first message may be transmitted over NR positioning protocol A (NRPPa) protocol. The removed third device may release the PRS resource accordingly after receiving 280 the first message.

In some example embodiments, the first device 201 may transmit 285 the configuration for the PRS resource to a third device added into the set of third devices 2031. In addition, the first device 201 may also determine a time offset or time window when the added third device should start to reserve the PRS resource based on the speed and trajectory of the second device 202. The first device 201 may transmit an indication of the time offset or the time window to the added third device. Additionally, the first device 201 may also transmit a request for reserving the PRS resource to the added third device. The configuration may be transmitted over the NRPPa protocol. The added third device receives 290 the configuration and reserves the PRS resource accordingly. It should be understood that the above illustrations and/or examples are described merely for purpose of description. The scope of the example embodiments is not limited in this respect.

In some example embodiments, the first device 201 may update 270 a set of fifth devices measuring the PRS, in accordance with a determination that the trigger event is detected. As an example, the first device 201 may update the set of fifth devices based on locations of the second device 202 and the plurality of third devices. For example, the first device 201 may determine the distance between the second device 202 and each of the plurality of third devices. If the distance is below a threshold, the corresponding third device may be added into the set of fifth devices. If the distance is larger than or equal to the threshold, the corresponding third device may be removed from set of fifth devices. It should be understood that the possible implementations of the update of the set of fifth devices described here are merely illustrative and therefore should not be construed as limiting the example embodiments in any way.

### Work Principle and Example Signaling for Resource Validation

As briefly mentioned with reference to FIG. 2, in some example embodiments, the first device 201 may transmit the validation condition for the PRS resource to the second device 202, and the second device 202 may invalidate the PRS resource accordingly. Example signaling charts for resource validation are now described.

The second device 202 may obtain an area configuration indicating a second area. The second area is an area in which the second device 202 can continue with transmitting the PRS without updating the configuration for the PRS resource. In some example embodiments, the second area may be a geographical area. In some alternative example embodiments, the second area may be a coverage of at least one third devices. As an example, the second area may comprise a plurality of cells. In some example embodiments, the second area may be same as the above mentioned first area. For example, the second area may be the RNA. Alternatively, the second area may be an area different from the first area, such as a positioning area of the second device 202. As an example, the second area may be an area of a factory in which the second device 202 is deployed. It should be understood that the second area may also be any other suitable specific area. The scope of the example embodiments is not limited in this respect.

As an example, the area configuration may indicate a geographical coverage of the second area. As a further example, the area configuration may indicate a plurality of cells that consist of the second area. In some example embodiments, the second device 202 may receive the area configuration from the first device 201. In some alternative example embodiments, the second device 202 may receive the area configuration from the fourth device. In some other example embodiments, the second device 202 may receive the area configuration from the sixth device 306. That is, at least one of the first device 201, the fourth device or the sixth device 306 may transmit the area configuration to the second device 202.

The second device 202 may determine whether the second device 202 leaves the second area. After the second device 202 moves out the second area, the second device 202 determines that it leaves the second area. Accordingly, the second device 202 may invalidate the PRS resource, and ceases transmitting the PRS on the PRS resource. In some additional example embodiments, the second device 202 may further transmit an indication that the resource is invalidated to at least one of the first device, the fourth device or the sixth device. In some additional example embodiments, the second device 202 may further transmit a request for a third area to at least one of the first device, the fourth device or the sixth device. Similar as the second area, the third area may be a geographical area or a coverage of at least one third devices.

FIG. 3 shows a signaling chart 300 for resource validation according to some example embodiments. As shown in FIG. 3, the signaling chart 300 involves the first device 201, the second device 202, a sixth device 306, a reservation set 303, and a measurement set 305. For the purpose of discussion, reference is made to FIG. 1A and FIG. 1B to describe the signaling chart 300. In some example embodiments, the sixth device 306 may be the AMF 140. The second device 202 may be in the RRC_INACTIVE state or RRC_IDLE state.

The reservation set 303 comprises one or more third devices. In some example embodiments, the reservation set 303 may comprise the set of third devices 303 selected by the first device 201 as described with reference to FIG. 2. In some example embodiments, the reservation set 303 may comprise the plurality of third devices in the first area in which the second device 202 is located.

The measurement set 305 comprises one or more third devices. In some example embodiments, the measurement set 305 may comprise the set of fifth devices selected by the first device 201 as described with reference to FIG. 2. In some example embodiments, the measurement set 305 may comprise any other suitable third devices in the first area in which the second device 202 is located.

Although one first device 201, one second device 202 and one sixth device 306 are illustrated in FIG. 3, it would be appreciated that there may be a plurality of first devices performing similar operations as described with respect to the first device 201 below, a plurality of second devices performing similar operations as described with respect to the second device 202 below, and a plurality of sixth devices performing similar operations as described with respect to the sixth device 306 below.

In the example of FIG. 3, the validation condition from the perspective of the second device 202 is the transmission of a message for updating the second area (also referred to as “update message” hereinafter) by the second device 202. After the second device 202 moves out the second area, the second device 202 may transmit 310 the update message to the sixth device 306. Based on (e.g., upon) the transmission of the update message, the second device 202 may invalidate 320 the resource, and cease 325 the transmission of the PRS on the PRS resource. In some additional example embodiments, the second device 202 may further transmit an indication that the resource is invalidated to at least one of the first device, the fourth device or the sixth device. In some additional example embodiments, the second device 202 may further transmit a request for a third area to at least one of the first device, the fourth device or the sixth device. In some example embodiments, the second area may be an RNA. For the example shown in FIG. 1B, after the terminal device 110 leaves the area 160-1, the terminal device 110 may transmit an RNA update message to the AMF 140. Based on (e.g., upon) the transmission of the RNA update message, the terminal device 110 may invalidate the PRS resource and stop transmitting the PRS on the resource.

Due to the movement of the second device 202, the sixth device 306 obtains update information concerning an update of the second area in which the second device 202 is located. In some example embodiments, the update information may be the update message. In some alternative example embodiments, the update information may an identification of a third area to which the second device 202 moves, which will be described in detail with reference to FIG. 4.

In the example of FIG. 3, the sixth device 306 receives 315 the update message from the second device 202. In accordance with receipt of the update message, the sixth device 306 transmits 330 to the first device 201 information indicating that the second device 202 leaves the second area (also referred to as “movement information” hereinafter). In some example embodiments, the movement information may be an indication that the second device 202 moves out of the second area. As an example, the movement information may be an explicit indication that the second device 202 has left the second area.

The first device 201 receives 335 the movement information. Based on the movement information, the first device 201 determines that the second device 202 moves out of the second area and invalidates 340 the PRS resource accordingly. In some example embodiments, the first device 201 may additionally transmit 345 a second message causing at least one third device in the reservation set 303 to release the PRS resource. For example, the first device 201 may transmit the second message to the devices in the reservation set 303. Based on (e.g., upon) receiving such a message, the devices in reservation set 303 may release the PRS resources.

In some example embodiments, the first device 201 may additionally transmit 350 a third message causing a fifth device in the measurement set 305 to cease measuring the PRS on the PRS resource. For example, the first device 201 may transmit the third message to the devices in the measurement set 305. Based on (e.g., upon) receiving the third message, the devices in the measurement set 305 may cease measuring the PRS on the PRS resource.

FIG. 4 shows another signaling chart 400 for resource validation according to some example embodiments. As shown in FIG. 4, the signaling chart 400 involves the first device 201, the second device 202, the sixth device 306, the reservation set 303, and the measurement set 305. For the purpose of discussion, reference is made to FIG. 1A and FIG. 1B to describe the signaling chart 400. In some example embodiments, the second device 202 may be in the RRC_INACTIVE state or RRC_IDLE state.

Although one first device 201, one second device 202 and one sixth device 306 are illustrated in FIG. 4, it would be appreciated that there may be a plurality of first devices performing similar operations as described with respect to the first device 201 below, a plurality of second devices performing similar operations as described with respect to the second device 202 below, and a plurality of sixth devices performing similar operations as described with respect to the sixth device 306 below.

In the example of FIG. 4, the validation condition from the perspective of the second device 202 is the receipt of an identification of a third area to which the second device 202 moves. As shown in FIG. 4, in some example embodiments, after the second device 202 moves out the second area, the second device 202 may transmit 410 the update message to the sixth device 306. After receiving 415 the update message, the sixth device 306 determines 430 a third area to which the second device 202 moves. The sixth device 306 transmits 435 an identification (ID) of the third area to the first device 201 and the second device 202. For the example shown in FIG. 1B, after the terminal device 110 leaves the area 160-1, the terminal device 110 may transmit an RNA update message to the AMF 140. The AMF 140 may determine a new RNA in which the terminal device 110 is located and transmit an ID for the new RNA to the terminal device 110 and the LMF 130.

In some alternative or additional example embodiments, the first device 201 may determine the location of the second device 202, such as an ID of a cell serving the second device 202 or a geographical location of the second device 202. Based on (e.g., upon) determining the second device leaves the second area, the first device 201 may transmit 420 assistance information to the sixth device 306. As an example, the assistance information may comprise IDs of physical cells, UL relative time of arrival (UL-RTOA), and/or the like. After receiving 425 the assistance information, the sixth device 306 determines 430 the third area to which the second device 202 moves, and transmits 435 the ID of the third area to the first device 201 and the second device 202. For the example shown in FIG. 1A and FIG. 1B, the LMF 130 may determine the assistance information based on positioning measurement information from location management units (LMUs), and transmit the assistance information to the AMF 140. The AMF 140 may determine a new RNA in which the terminal device 110 is located and transmit an ID for the new RNA to the terminal device 110 and the LMF 130.

Based on (e.g., upon) receiving 440 the ID of the third area, the second device 202 may invalidate 445 the resource and cease 450 the transmission of the PRS on the PRS resource. In some additional example embodiments, the second device 202 may further transmit an indication that the resource is invalidated to at least one of the first device, the fourth device or the sixth device.

At the side of the first device 201, it receives 455 the ID of the third area. Based on the receipt of the ID, the first device 201 determines that the second device 202 moves out of the second area and invalidates 460 the PRS resource accordingly. In some example embodiments, the first device 201 may additionally transmit 465 a second message causing at least one third device in the reservation set 303 to release the PRS resource. For example, the first device 201 may transmit the second message to the devices in the reservation set 303. Based on (e.g., upon) receiving the second message, the devices in reservation set 303 may release the PRS resources.

In some additional example embodiments, the first device 201 may additionally transmit 470 a third message causing a fifth device in the measurement set 305 to cease measuring the PRS on the PRS resource. For example, the first device 201 may transmit the third message to the devices in the measurement set 305. Based on (e.g., upon) receiving the third message, the devices in the measurement set 305 may cease measuring the PRS on the PRS resource.

As can be seen from the above description, in aid of the indication of the validation condition, the example embodiments can check the validity of the resource and invalidate the resource timely. Thereby, the example embodiments can improve the resource efficiency.

### Example Methods

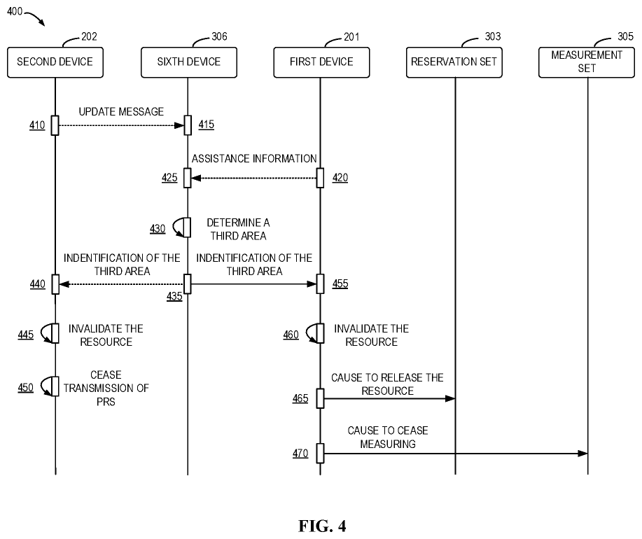

FIG. 5 shows a flowchart of an example method 500 implemented at a first device in accordance with some example embodiments. For the purpose of discussion, the method 500 will be described from the perspective of the first device 201 in FIG. 2, FIG. 3 and FIG. 4.

At 502, the first device 201 obtains a configuration indicating a resource for a positioning reference signal for a second device 202 in a first area. At 504, the first device 201 selects, from a plurality of third devices in the first area, a set of third devices 2031 by which the resource is to be reserved. At 506, the first device 201 transmits the configuration to the set of third devices 2031.

In some example embodiments, the set of third devices 2031 are selected based on at least one of the following: a location of the second device 202, locations of the plurality of third devices, a location of a fourth device 204 serving the second device 202, or a signal quality of the positioning reference signal received by a set of fifth devices measuring the second device 202.

In some example embodiments, the first device 201 further detects a trigger event related to movement of the second device 202. In accordance with a determination that the trigger event is detected, the first device 201 updates the set of third devices 2031.

In some example embodiments, the trigger event comprises at least one of the following: a change of a location of the second device 202, a degradation of a signal quality of the positioning reference signal received by a set of fifth devices measuring the second device 202, a change of a fourth device 204 serving the second device 202, or the second device 202 leaving the first area.

In some example embodiments, the set of third devices 2031 is updated based on at least one of the following: a location of the second device 202, locations of the plurality of third devices, a location of a fourth device 204 serving the second device 202, or a signal quality of the positioning reference signal received by a set of fifth devices measuring the second device 202.

In some example embodiments, the first device 201 further transmits, to a third device removed from the set of third devices 2031, a first message causing the third device to release the resource. The first device 201 further transmits, to a third device added into the set of third devices 2031, at least the configuration for reserving the resource by the third device.

In some example embodiments, in accordance with a determination that the trigger event is detected, the first device 201 updates a set of fifth devices measuring the positioning reference signal.

In some example embodiments, the first device 201 receives, from a sixth device 306, information indicating that the second device 202 leaves a second area. Based on the receipt of the information, the first device 201 transmits a second message causing at least one of the set of third devices 2031 to release the resource.

In some example embodiments, based on the receipt of the information, the first device 201 transmits a third message causing a fifth device to cease measuring the positioning reference signal on the resource.

In some example embodiments, the information includes an indication that the second device 202 leaves the second area. The first device 201 transmits an indication of a validation condition, so that the second device 202 invalidates the resource based on (e.g., upon) a transmission of a message for updating the second area.

In some example embodiments, the information includes an identification of a third area to which the second device 202 moves. The first device 201 transmits an indication of a validation condition, so that the second device 202 invalidates the resource based on (e.g., upon) the receipt of the identification of the third area.

In some example embodiments, receiving the information comprises: transmitting, to the sixth device 306, assistance information for assisting in updating the second area; and receiving, from the sixth device 306, the identification of the third area.

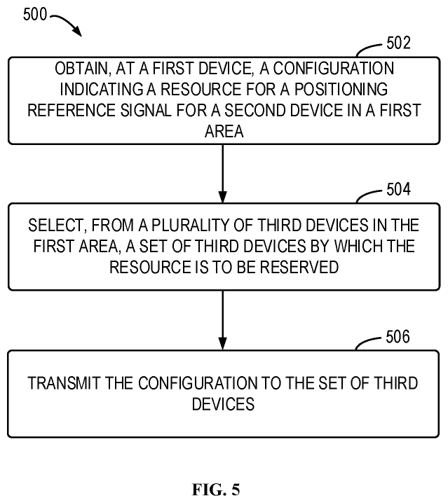

FIG. 6 shows a flowchart of an example method 600 implemented at a second device in accordance with some example embodiments. For the purpose of discussion, the method 600 will be described from the perspective of the second device 202 in FIG. 2, FIG. 3 and FIG. 4.

At 602, the second device 202 receives, from a fourth device 204 serving the second device 202 in a first area or a first device 201, a configuration indicating a resource for a positioning reference signal for the second device 202. In some example embodiments, the resource may be reserved by a set of third devices 2031 selected from a plurality of third devices in the first area. At 604, the second device 202, transmitting, to a fifth device measuring the positioning reference signal, the positioning reference signal by using the resource.

In some example embodiments, the second device 202 further obtains an area configuration indicating a second area.

In some example embodiments, the second device 202 further determines whether the second device leaves the second area. In accordance with a determination that the second device leaves the second area, the second device invalidates the resource and ceases transmission of the positioning reference signal on the resource.

In some example embodiments, the second device 202 further transmits an indication that the resource is invalidated.

In some example embodiments, the second device 202 further transmits a request for a third area in accordance with a determination that the second device leaves the second area.

In some example embodiments, the second device 202 further transmits a message for updating a second area to a sixth device 306. Based on the transmission of the message, the second device 202 invalidates the resource, and ceases transmission of the positioning reference signal on the resource.

In some example embodiments, the second device 202 receives an indication of a validation condition from the first device 201, so that the second device 202 invalidates the resource based on (e.g., upon) the transmission of the message.

In some example embodiments, the second device 202 receives, from a sixth device 306, an identification of a third area to which the second device 202 moves. Based on the receipt of the identification, the second device 202 invalidates the resource, and ceases transmission of the positioning reference signal on the resource.

In some example embodiments, the second device 202 receives an indication of a validation condition from the first device 201, so that the second device 202 invalidates the resource based on (e.g., upon) the receipt of the identification.

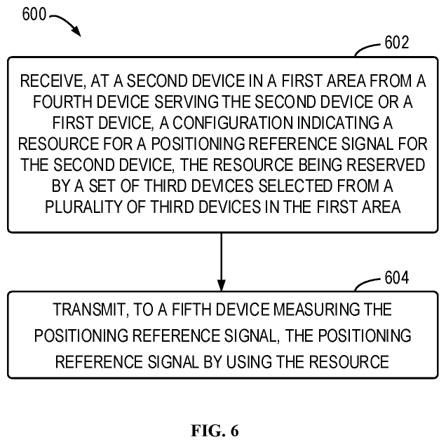

FIG. 7 shows a flowchart of an example method 700 implemented at a third device in accordance with some example embodiments. For the purpose of discussion, the method 700 will be described from the perspective of one of the set of third devices 2031 in FIG. 2.

At 702, the third device receives, from a first device 201, a configuration indicating a resource for a positioning reference signal for a second device 202 in a first area. The third device is selected from a plurality of third devices in the first area. At 704, the third device reserves the resource for the positioning reference signal based on the configuration.

In some example embodiments, the third device receives, from the first device 201, a first message causing the third device to release the resource. Based on the receipt of the first message, the third device releases the resource. In some example embodiments, the first message may be received after the third device is removed from the selected set of third devices. In some alternative example embodiments, the first message may be received after the resource is invalidated.

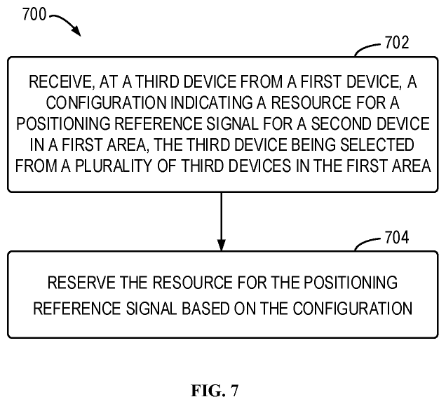

FIG. 8 shows a flowchart of an example method 800 implemented at a fourth device in accordance with some example embodiments. For the purpose of discussion, the method 800 will be described from the perspective of the fourth device 204 in FIG. 2.

At 802, the fourth device 204 determines a resource for a positioning reference signal for a second device 202 in a first area. At 804, the fourth device 204 transmits a configuration indicating the resource to a first device 201 and the second device 202. The resource is reserved by a set of third devices 2031 selected by the first device 201 from a plurality of third devices in the first area.

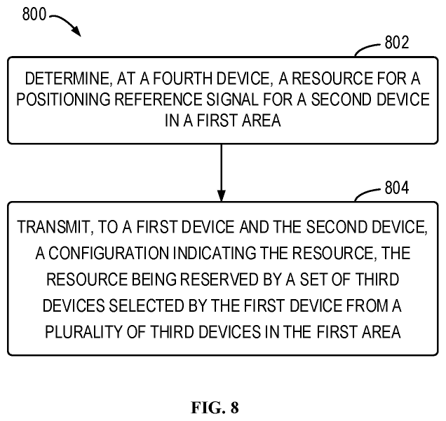

FIG. 9 shows a flowchart of an example method 900 implemented at a sixth device in accordance with some example embodiments. For the purpose of discussion, the method 900 will be described from the perspective of the sixth device 306 in FIG. 3 and FIG. 4.

At 902, the sixth device 306 obtains update information concerning an update of a second area in which a second device 202 is located. At 904, based on the obtaining of the update information, the sixth device 306 transmits, to a first device 201, information indicating that the second device 202 leaves the second area.

In some example embodiments, obtaining the update information comprises receiving, from the first device 201, assistance information assisting in updating the second area. Transmitting the information comprises: determining, based on the assistance information, a third area to which the second device 202 moves; and transmitting, to the first device 201 and the second device 202, an identification of the third area.

In some example embodiments, obtaining the update information comprises: receiving, from the second device 202, a message for updating the second area. Transmitting the information comprises: determining a third area to which the second device 202 moves; and transmitting, to the first device 201 and the second device 202, an identification of the third area.

In some example embodiments, the information includes an indication that the second device 202 leaves the second area, and wherein obtaining the update information comprises receiving, from the second device 202, a message for updating the second area.

### Example Apparatus, Device and Medium

In some example embodiments, a first apparatus capable of performing any of the method 500 (for example, the first device 201 in FIG. 2, FIG. 3 and FIG. 4) may comprise means for performing the respective operations of the method 500. The means may be implemented in any suitable form. For example, the means may be implemented in a circuitry or software module. The first apparatus may be implemented as or included in the first device 201 in FIG. 2, FIG. 3 and FIG. 4.

In some example embodiments, the first apparatus comprises: means for obtaining a configuration indicating a resource for a positioning reference signal for a second apparatus in a first area; means for selecting, from a plurality of third apparatuses in the first area, a set of third apparatuses by which the resource is to be reserved; and means for transmitting the configuration to the set of third apparatuses.

In some example embodiments, the set of third apparatuses are selected based on at least one of the following: a location of the second apparatus, locations of the plurality of third apparatuses, a location of a fourth apparatus serving the second apparatus, or a signal quality of the positioning reference signal received by a set of fifth apparatuses measuring the second apparatus.

In some example embodiments, the first apparatus further comprises: means for detecting a trigger event related to movement of the second apparatus; and means for in accordance with a determination that the trigger event is detected, updating the set of third apparatuses.

In some example embodiments, the trigger event comprises at least one of the following: a change of a location of the second apparatus, a degradation of a signal quality of the positioning reference signal received by a set of fifth apparatuses measuring the second apparatus, a change of a fourth apparatus serving the second apparatus, or the second apparatus leaving the first area.

In some example embodiments, the set of third apparatuses is updated based on at least one of the following: a location of the second apparatus, locations of the plurality of third apparatuses, a location of a fourth apparatus serving the second apparatus, or a signal quality of the positioning reference signal received by a set of fifth apparatuses measuring the second apparatus.

In some example embodiments, the first apparatus further comprises: means for transmitting, to a third apparatus removed from the set of third apparatuses, a first message causing the third apparatus to release the resource; and means for transmitting, to a third apparatus added into the set of third apparatuses, at least the configuration for reserving the resource by the third apparatus.

In some example embodiments, the first apparatus further comprises means for updating a set of fifth apparatuses measuring the positioning reference signal in accordance with a determination that the trigger event is detected.

In some example embodiments, the first apparatus further comprises: means for receiving, from a sixth apparatus, information indicating that the second apparatus leaves a second area; and means for transmitting, based on the receipt of the information, a second message causing at least one of the set of third apparatuses to release the resource.

In some example embodiments, the first apparatus further comprises: means for transmitting, based on the receipt of the information, a third message causing a fifth apparatus to cease measuring the positioning reference signal on the resource.

In some example embodiments, the information includes an indication that the second apparatus leaves the second area. The first apparatus further comprises: means for transmitting an indication of a validation condition, so that the second apparatus invalidates the resource based on (e.g., upon) a transmission of a message for updating the second area.

In some example embodiments, the information includes an identification of a third area to which the second apparatus moves. The first apparatus further comprises: means for transmitting an indication of a validation condition, so that the second apparatus invalidates the resource based on (e.g., upon) the receipt of the identification of the third area.

In some example embodiments, means for receiving the information comprises: means for transmitting, to the sixth apparatus, assistance information for assisting in updating the second area; and means for receiving, from the sixth apparatus, the identification of the third area.

In some example embodiments, a second apparatus capable of performing any of the method 600 (for example, the second device 202 in FIG. 2, FIG. 3 and FIG. 4) may comprise means for performing the respective operations of the method 600. The means may be implemented in any suitable form. For example, the means may be implemented in a circuitry or software module. The second apparatus may be implemented as or included in the second device 202 in FIG. 2, FIG. 3 and FIG. 4.

In some example embodiments, the second apparatus comprises: means for receiving, from a fourth apparatus serving the second apparatus in a first area or a first apparatus, a configuration indicating a resource for a positioning reference signal for the second apparatus; and means for transmitting, to a fifth apparatus measuring the positioning reference signal, the positioning reference signal by using the resource. In some example embodiments, the resource may be reserved by a set of third apparatuses selected from a plurality of third apparatuses in the first area.

In some example embodiments, the second apparatus further comprises: means for obtaining an area configuration indicating a second area.

In some example embodiments, the second apparatus further comprises: means for determining whether the second apparatus leaves the second area; means for invalidating the resource in accordance with a determination that the second apparatus leaves the second area; and means for ceasing transmission of the positioning reference signal on the resource in accordance with a determination that the second apparatus leaves the second area.

In some example embodiments, the second apparatus further comprises: means for transmitting an indication that the resource is invalidated.

In some example embodiments, the second apparatus further comprises: means for transmitting a request for a third area in accordance with a determination that the second device leaves the second area.

In some example embodiments, the second apparatus further comprises: means for transmitting, to a sixth apparatus, a message for updating a second area; means for invalidating the resource based on the transmission of the message, and means for ceasing, based on the transmission of the message, transmission of the positioning reference signal on the resource.

In some example embodiments, the second apparatus further comprises: means for receiving, from the first apparatus, an indication of a validation condition, so that the second apparatus invalidates the resource based on (e.g., upon) the transmission of the message.

In some example embodiments, the second apparatus further comprises: means for receiving, from a sixth apparatus, an identification of a third area to which the second apparatus moves; and means for invalidating the resource based on the receipt of the identification, and means for ceasing, based on the receipt of the identification, transmission of the positioning reference signal on the resource.

In some example embodiments, the second apparatus further comprises: means for receiving, from the first apparatus, an indication of a validation condition, so that the second apparatus invalidates the resource based on (e.g., upon) the receipt of the identification.

In some example embodiments, a third apparatus capable of performing any of the method 700 (for example, one of the set of third devices 2031 in FIG. 2) may comprise means for performing the respective operations of the method 700. The means may be implemented in any suitable form. For example, the means may be implemented in a circuitry or software module. The third apparatus may be implemented as or included in one of the set of third devices 2031 in FIG. 2.

In some example embodiments, the third apparatus comprises: means for receiving, from a first apparatus, a configuration indicating a resource for a positioning reference signal for a second apparatus in a first area, the third apparatus being selected from a plurality of third apparatuses in the first area; and means for reserving the resource for the positioning reference signal based on the configuration.

In some example embodiments, the third apparatus further comprises: means for receiving, from the first apparatus, a first message causing the third apparatus to release the resource; and means for releasing the resource based on the receipt of the first message.

In some example embodiments, a fourth apparatus capable of performing any of the method 800 (for example, the fourth device 204 in FIG. 2) may comprise means for performing the respective operations of the method 800. The means may be implemented in any suitable form. For example, the means may be implemented in a circuitry or software module. The fourth apparatus may be implemented as or included in the fourth device 204 in FIG. 2.

In some example embodiments, the fourth apparatus comprises: means for determining a resource for a positioning reference signal for a second apparatus in a first area; and means for transmitting, to a first apparatus and the second apparatus, a configuration indicating the resource, the resource being reserved by a set of third apparatuses selected by the first apparatus from a plurality of third apparatuses in the first area.

In some example embodiments, a sixth apparatus capable of performing any of the method 900 (for example, the sixth device 306 in FIG. 3 and FIG. 4) may comprise means for performing the respective operations of the method 900. The means may be implemented in any suitable form. For example, the means may be implemented in a circuitry or software module. The sixth apparatus may be implemented as or included in the sixth device 306 in FIG. 3 and FIG. 4.

In some example embodiments, the sixth apparatus comprises: means for obtaining update information concerning an update of a second area in which a second apparatus is located; and means for transmitting, to a first apparatus based on the obtaining of the update information, information indicating that the second apparatus leaves the second area.

In some example embodiments, the means for obtaining the update information comprises: means for receiving, from the first apparatus, assistance information assisting in updating the second area. The means for transmitting the information comprises: means for determining, based on the assistance information, a third area to which the second apparatus moves; and means for transmitting, to the first apparatus and the second apparatus, an identification of the third area.

In some example embodiments, the means for obtaining the update information comprises: means for receiving, from the second apparatus, a message for updating the second area. The means for transmitting the information comprises: means for determining a third area to which the second apparatus moves; and means for transmitting, to the first apparatus and the second apparatus, an identification of the third area.

In some example embodiments, the information includes an indication that the second apparatus leaves the second area. The means for obtaining the update information comprises: means for receiving, from the second apparatus, a message for updating the second area.

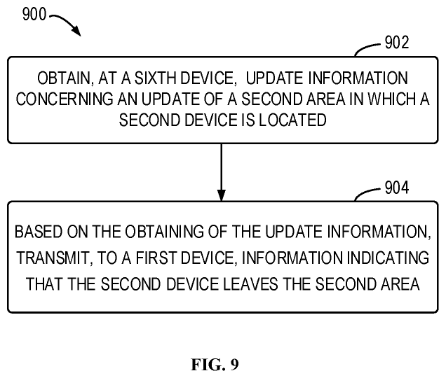

FIG. 10 is a simplified block diagram of a device 1000 that is suitable for implementing example embodiments. The device 1000 may be provided to implement a communication device, for example, the first device 201, the second device 202, the fourth device 204, the sixth device 306, or one of the set of third devices 2031 as shown in FIG. 2, FIG. 3 or FIG. 4. As shown, the device 1000 includes one or more processors 1010, one or more memories 1020 coupled to the processor 1010, and one or more communication modules 1040 coupled to the processor 1010.

The communication module 1040 is for bidirectional communications. The communication module 1040 has one or more communication interfaces to facilitate communication with one or more other modules or devices. The communication interfaces may represent any interface for communication with other network elements. In some example embodiments, the communication module 1040 may include at least one antenna.

The processor 1010 may be of any type suitable to the local technical network and may include one or more of the following: general purpose computers, special purpose computers, microprocessors, digital signal processors (DSPs) and processors based on multicore processor architecture, as non-limiting example embodiments. The device 1000 may have multiple processors, such as an application specific integrated circuit chip that is slaved in time to a clock which synchronizes the main processor.

The memory 1020 may include one or more non-volatile memories and one or more volatile memories. Example embodiments of the non-volatile memories include, but are not limited to, a Read Only Memory (ROM) 1024, an electrically programmable read only memory (EPROM), a flash memory, a hard disk, a compact disc (CD), a digital video disk (DVD), an optical disk, a laser disk, and other magnetic storage and/or optical storage. Example embodiments of the volatile memories include, but are not limited to, a random access memory (RAM) 1022 and other volatile memories that will not last in the power-down duration.

A computer program 1030 includes computer executable instructions that are executed by the associated processor 1010. The instructions of the program 1030 may include instructions for performing operations/acts of some example embodiments. The program 1030 may be stored in the memory, e.g., the ROM 1024. The processor 1010 may perform any suitable actions and processing by loading the program 1030 into the RAM 1022.

The example embodiments may be implemented by means of the program 1030 so that the device 1000 may perform any process as discussed with reference to FIG. 2 to FIG. 9. The example embodiments may also be implemented by hardware or by a combination of software and hardware.

In some example embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

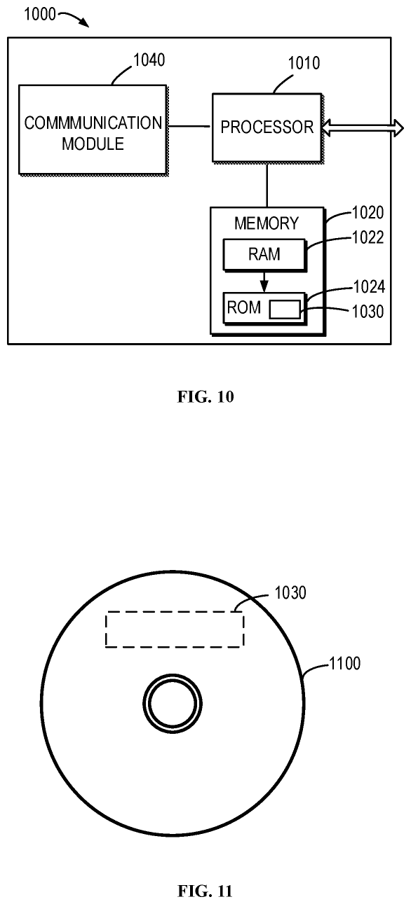

FIG. 11 shows an example embodiment of the computer readable medium 1100 which may be in form of CD, DVD or other optical storage disk. The computer readable medium 1100 has the program 1030 stored thereon.

Generally, various example embodiments may be implemented in hardware or special purpose circuits, software, logic or any combination thereof. Some example embodiments may be implemented in hardware, while other aspects may be implemented in firmware or software which may be executed by a controller, microprocessor or other computing device. While various aspects of example embodiments are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the example embodiments may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the example embodiments, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific example embodiments of the computer readable storage medium may include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve results described herein. In certain circumstances, multitasking and parallel processing may be advantageous. Likewise, while several specific implementation details are contained in the above discussions, these should not be construed as limitations on the scope of the example embodiments, but rather as descriptions of features that may be specific to particular example embodiments. Unless explicitly stated, certain features that are described in the context of separate example embodiments may also be implemented in combination in a single example embodiment. Conversely, unless explicitly stated, various features that are described in the context of a single example embodiment may also be implemented in a plurality of example embodiments separately or in any suitable sub-combination.

Although the example embodiments have been described in languages specific to structural features and/or methodological acts, it is to be understood that the example embodiments are not necessarily limited to the specific features or acts described above. Rather, the specific features and acts described above are disclosed as example forms of implementing the claims.

1-44. (canceled)

45. A first device comprising:
at least one processor; and
at least one memory storing instructions that, when executed by the at least one processor, cause the first device at least to:
obtain a configuration indicating a resource for a positioning reference signal for a second device in a first area;
select, from a plurality of third devices in the first area, a set of third devices by which the resource is to be reserved; and
transmit the configuration to the set of third devices.

46. The first device of claim 45, wherein the set of third devices are selected based on at least one of the following:
a location of the second device,
locations of the plurality of third devices,
a location of a fourth device serving the second device, or
a signal quality of the positioning reference signal received by a set of fifth devices measuring the second device.

47. The first device of claim 45, wherein the first device is further caused to:
detect a trigger event related to movement of the second device; and
in accordance with a determination that the trigger event is detected, update the set of third devices.

48. The first device of claim 47, wherein the trigger event comprises at least one of the following:
a change of a location of the second device,
a degradation of a signal quality of the positioning reference signal received by a set of fifth devices measuring the second device,
a change of a fourth device serving the second device, or
the second device leaving the first area.

49. The first device of claim 47, wherein the set of third devices is updated based on at least one of the following:
a location of the second device,
locations of the plurality of third devices,
a location of a fourth device serving the second device, or
a signal quality of the positioning reference signal received by a set of fifth devices measuring the second device.

50. A second device comprising:
at least one processor; and
at least one memory storing instructions that, when executed by the at least one processor, cause the second device in a first area at least to:
receive, from a fourth device serving the second device or a first device, a configuration indicating a resource for a positioning reference signal for the second device, the resource being reserved by a set of third devices selected from a plurality of third devices in the first area; and
transmit, to a fifth device measuring the positioning reference signal, the positioning reference signal by using the resource.

51. The second device of claim 50, wherein the second device is further caused to:
obtain an area configuration indicating a second area.

52. The second device of claim 51, wherein the second device is further caused to:
determine whether the second device leaves the second area; and
in accordance with a determination that the second device leaves the second area,
invalidate the resource, and
cease transmission of the positioning reference signal on the resource.

53. The second device of claim 52, wherein the second device is further caused to:
transmit an indication that the resource is invalidated.

54. The second device of claim 52, wherein the second device is further caused to:
in accordance with a determination that the second device leaves the second area, transmit a request for a third area.

55. The second device of claim 51, wherein the second device is further caused to:
transmit, to a sixth device, a message for updating the second area; and
based on the transmission of the message,
invalidate the resource, and
cease transmission of the positioning reference signal on the resource.

56. The second device of claim 55, wherein the second device is further caused to:
receive, from the first device, an indication of a validation condition, so that the second device invalidates the resource based on the transmission of the message.

57. The second device of claim 50, wherein the second device is further caused to:
receive, from a sixth device, an identification of a third area to which the second device moves; and
based on the receipt of the identification,
invalidate the resource, and
cease transmission of the positioning reference signal on the resource.

58. The second device of claim 57, wherein the second device is further caused to:
receive, from the first device, an indication of a validation condition, so that the second device invalidates the resource based on the receipt of the identification.

59. A sixth device comprising:
at least one processor; and
at least one memory storing instructions that, when executed by the at least one processor, cause the sixth device at least to:
obtain update information concerning an update of a second area in which a second device is located; and
based on the obtaining of the update information, transmit, to a first device, information indicating that the second device leaves the second area.

60. The sixth device of claim 59, wherein to obtain the update information, the sixth device is caused to:
receive, from the first device, assistance information assisting in updating the second area, and
wherein to transmit the information, the sixth device is caused to:
determine, based on the assistance information, a third area to which the second device moves; and
transmit, to the first device and the second device, an identification of the third area.

61. The sixth device of claim 59, wherein to obtain the update information, the sixth device is caused to:
receive, from the second device, a message for updating the second area, and
wherein to transmit the information, the sixth device is caused to:
determine a third area to which the second device moves; and
transmit, to the first device and the second device, an identification of the third area.

62. The sixth device of claim 59, wherein the information includes an indication that the second device leaves the second area, and wherein obtain the update information comprises:
receive, from the second device, a message for updating the second area.

63. The sixth device of claim 59, wherein the first device comprises a device in a core network, the second device comprises a terminal device, and the sixth device comprises a device in the core network.
